(19) United States
(12) Patent Application Publication
(10) Pub. No.: US 2012/0057097 A1
(43) Pub. Date: Mar. 8, 2012

(54) LIGHTING DEVICE, DISPLAY DEVICE AND TELEVISION RECEIVER

(75) Inventor: Takaharu Shimizu, Osaka-shi (JP)

(73) Assignee: SHARP KABUSHIKI KAISHA, Osaka-shi, Osaka (JP)

(21) Appl. No.: 13/319,688

(22) PCT Filed: Apr. 6, 2010
(86) PCT No.: PCT/JP2010/056219

§ 371 Date: Nov. 10, 2011

(30) Foreign Application Priority Data
Jun. 15, 2009 (JP) 2009-142328

(51) Int. Cl. G02F 1/1335; F21V 5/04; G09F 13/04; F21V 21/00

(52) U.S. Cl. 349/61; 362/249.01; 362/235; 362/249.02; 362/225; 362/97.1

(57) ABSTRACT

It is an object of the present invention to provide a lighting device having a simple configuration and obtaining an almost uniform illumination brightness distribution as a whole. A lighting device 12 of the present invention includes a plurality of light sources 17 arranged parallel to each other, and a chassis 14 having a bottom plate 14a on which the light sources 17 are arranged. Some of the light sources 17 are arranged on either side of a center line CL of the bottom plate at a center with respect to a parallel arrangement direction of the light sources 17 in the light source high-density areas HD in which a distance between the adjacent light sources 17, 17 is smaller than a distance between the adjacent light sources of others of the light sources 17 in another area.

### TECHNICAL FIELD

The present invention relates to a lighting device, a display device and a television receiver.

### BACKGROUND ART

A liquid crystal panel used for a liquid crystal display device such as a liquid crystal television, for example, does not emit light, and thus a backlight unit is required as a separate lighting device. This backlight unit is known, which is placed behind the liquid crystal panel (on a side opposite to a display surface side). The backlight unit includes numerous light sources (for example, fluorescent lamps).

When the numerous fluorescent lamps are arranged at equal intervals in the backlight unit, light tends to be converged to a center part from the fluorescent lamps, and thus a brightness of the center part is comparatively increased. On the other hand, brightness of an end part tends to be comparatively decreased. Then, a device described in Patent Document 1 is known as a backlight unit in which an arrangement interval between fluorescent lamps is changed in respective regions. In the backlight unit, a plurality of fluorescent lamps is divided into a first group located on an upper side and a second group located on a lower side of the first group. An interval between the adjacent fluorescent lamps in the first group is narrower than an interval between the adjacent fluorescent lamps in the second group. Such a configuration can suppress reduction in brightness on the upper side of the backlight unit.
Patent Document 1: Japanese Unexamined Patent Publication No. 2005-251437

### PROBLEM TO BE SOLVED BY THE INVENTION

In the backlight unit disclosed in Patent Document 1, only a case where the backlight unit is used such that a front surface thereof is taken along a vertical direction is assumed. However, the liquid crystal display device comprising the backlight unit has various installation modes. In fact, for example, the liquid crystal display device may be placed in a direction oblique to the vertical direction. Brightness reduction may disadvantageously occur in a lower end part or a side end part depending on a placing environment.

### DISCLOSURE OF THE PRESENT INVENTION

The present invention was made in view of the foregoing circumstances. It is an object of the present invention to provide a lighting device having a simple configuration, and obtaining an almost uniform illumination brightness distribution as a whole. It is another object of the present invention to provide a display device comprising the lighting device. It is still another object of the present invention to provide a television receiver comprising the display device.

### MEANS FOR SOLVING THE PROBLEM

To solve the above problem, a lighting device of the present invention includes a plurality of light sources arranged parallel to each other, and a chassis having a bottom plate on which the light sources are arranged. Some of the plurality of light sources are arranged on either side of a center line of the bottom plate at a center with respect to a parallel arrangement direction of the plurality of light sources in a light source high-density area in which a distance between the adjacent light sources is smaller than a distance between the adjacent light sources of others of the plurality of light sources in another area.

According to such a configuration, an amount of illumination light can be increased in the light source high-density area. When the light sources are arranged at equal intervals over the entire lighting device, brightness at upper and lower end parts or right and left end parts of the lighting device tend to be lower than that at the center part. However, according to the configuration of the present invention, for example, the light source high-density areas are arranged in the upper and lower end parts and right and left end parts which exist at both sides sandwiching the center line therebetween. Thereby, brightness upon the upper and lower end parts or right and left end parts can be improved. Thus, illumination brightness can be partially adjusted by the simple configuration, and an almost uniform illumination brightness distribution can be obtained over the entire lighting device.

### BRIEF DESCRIPTION OF THE DRAWINGS

FIG. 1 is an exploded perspective view illustrating a schematic configuration of a television receiver according to a first embodiment of the present invention;

FIG. 2 is an exploded perspective view illustrating a schematic configuration of a liquid crystal display device included in the television receiver;

FIG. 3 is a cross-sectional view illustrating a cross-sectional configuration along a long-side direction of the liquid crystal display device;

FIG. 4 is a cross-sectional view illustrating a cross-sectional configuration along a short-side direction of the liquid crystal display device;

FIG. 5 is an enlarged sectional view of an essential part illustrating a configuration of a member attached to an LED substrate;

FIG. 6 is an enlarged sectional view of an essential part illustrating a configuration of a member attached to an LED substrate;

FIG. 7 is a view schematically illustrating an arrangement mode of LEDs in a chassis;

FIG. 8 is a view schematically illustrating a modification of the arrangement mode of the LEDs in the chassis;

FIG. 9 is a view schematically illustrating another modification of the arrangement mode of the LEDs in the chassis;

FIG. 10 is a view schematically illustrating still another modification of the arrangement mode of the LEDs in the chassis;

FIG. 11 is a perspective view illustrating a schematic configuration of a cold-cathode tube included in a backlight device according to a second embodiment;

FIG. 12 is a view schematically illustrating an arrangement mode of cold-cathode tubes in a chassis; and

FIG. 13 is a view schematically illustrating a modification of the arrangement mode of the cold-cathode tubes in the chassis.

### BEST MODE FOR CARRYING OUT THE INVENTION

### First Embodiment

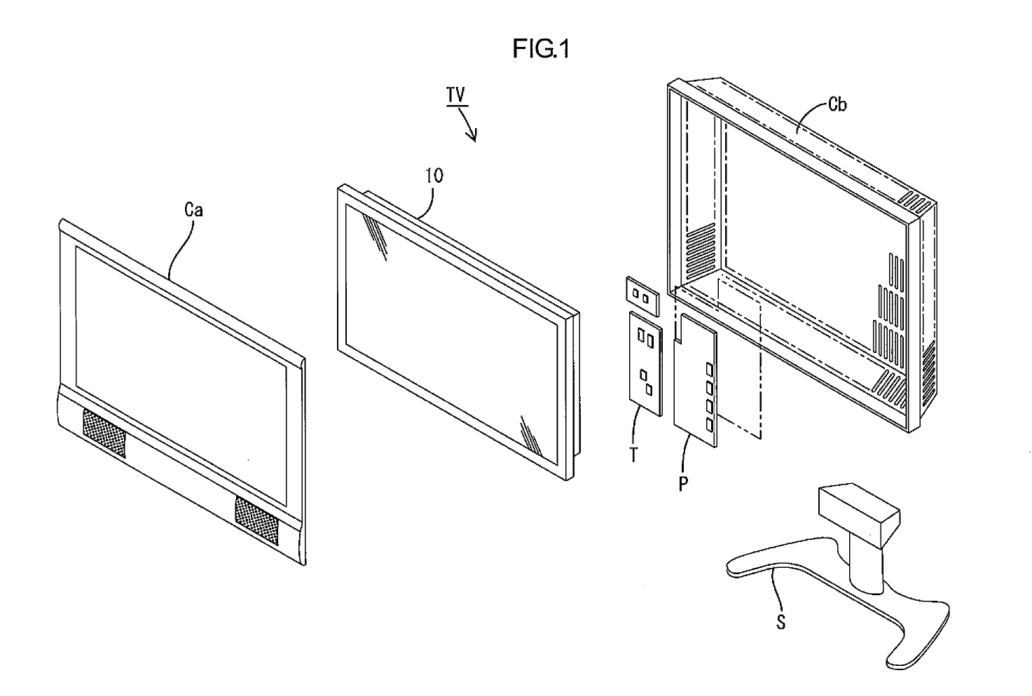

A first embodiment of the present invention will be described with reference to FIGS. 1 to 7.

First, a configuration of a television receiver TV comprising a liquid crystal display device 10 will be described.

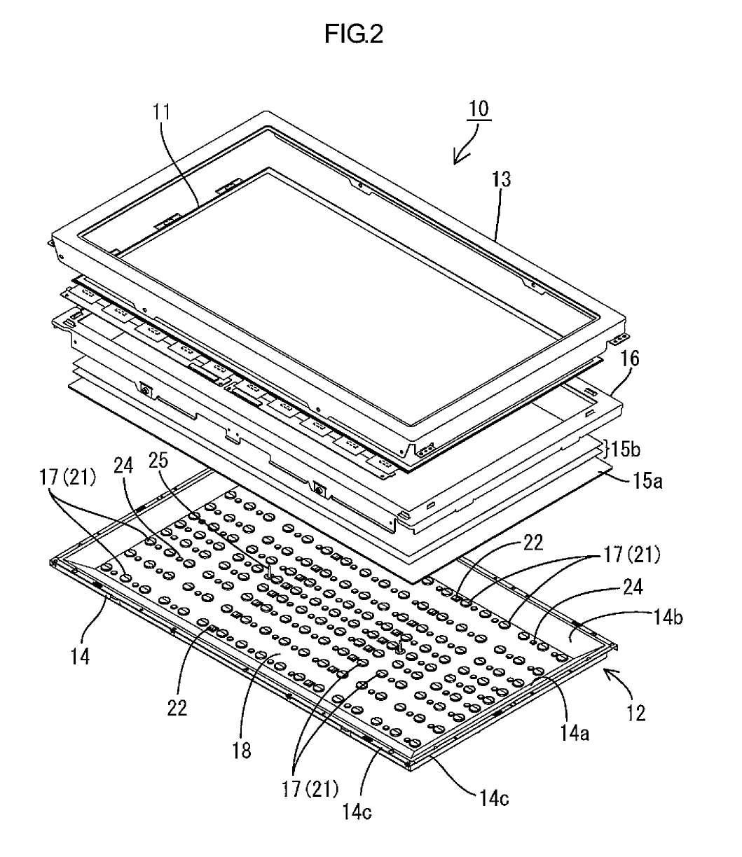

As illustrated in FIG. 1, the television receiver TV of the present embodiment comprises the liquid crystal display device 10, front and rear cabinets Ca, Cb which house the liquid crystal display device 10 therebetween, a power source P, a tuner T and a stand S. An entire shape of the liquid crystal display device (display device) 10 is a landscape rectangular. The liquid crystal display device 10 is housed in a vertical position. As illustrated in FIG. 2, the liquid crystal display device 10 comprises a liquid crystal panel 11 as a display panel, and a backlight device (lighting device) 12 as an external light source. The liquid crystal panel 11 and the backlight device 12 are integrally held by a frame shaped bezel 13 and the like.

Next, the liquid crystal panel 11 and the backlight device 12 included in the liquid crystal display device 10 will be described (see FIGS. 2 to 4).

The liquid crystal panel (display panel) 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. Polarizing plates are attached to outer surfaces of the substrates.

As illustrated in FIG. 2, the backlight device 12 comprises a chassis 14, an optical sheet set 15 (a diffuser 15a, and a plurality of optical sheets 15b which are provided between the diffuser 15a and the liquid crystal panel 11), and a frame 16. The chassis 14 has a substantially box-shape, and opens to the light output side (on the liquid crystal panel 11 side). The optical sheet set 15 is provided so as to cover the opening of the chassis 14. The frame 16 provided along an outer edge of the chassis 14 holds an outer edge part of the diffuser 15a in a state where the outer edge part is sandwiched between the frame 16 and the chassis 14. Furthermore, LEDs (light sources, point light sources) 17 are arranged in the chassis 14. Alight output side of the backlight device 12 is a side closer to the diffuser 15a than the LEDs 17.

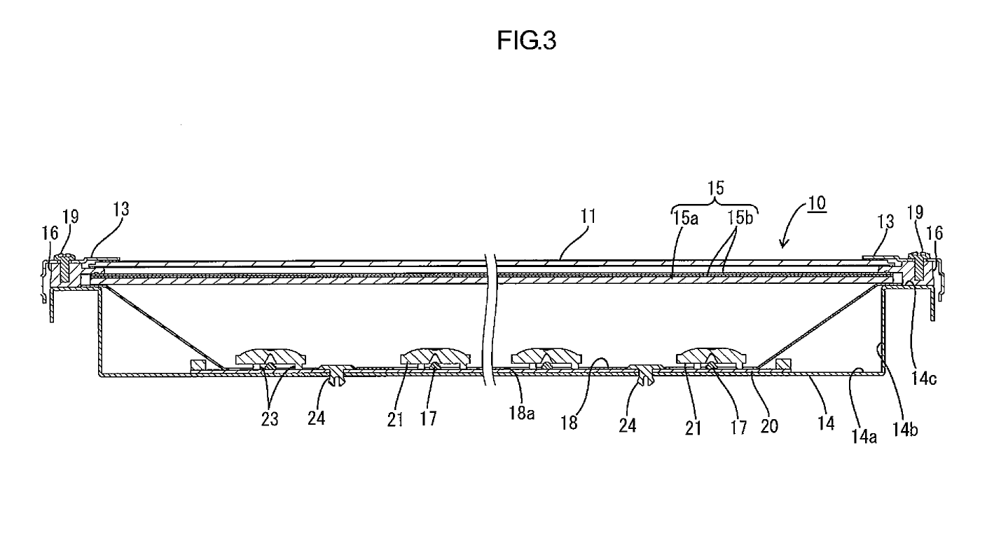

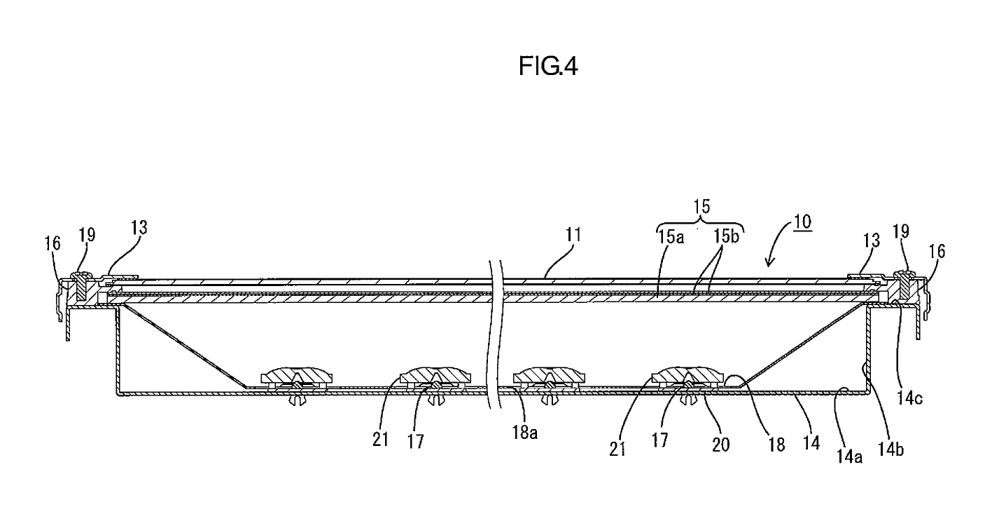

The chassis 14 is made of metal. The chassis 14 includes a rectangular bottom plate 14a like the liquid crystal panel 11, side plates 14b each of which rises from an outer edge of the corresponding side of the bottom plate 14a, and a receiving plate 14c outwardly overhanging from a rising edge of each of the side plates 14b. An entire shape of the chassis 14 is a substantially shallow box shape opened to the front side. As illustrated in FIGS. 3 and 4, the frame 16 is placed on the receiving plate 14c of the chassis 14. Outer edge parts of a reflection sheet 18 and optical sheet set 15 to be described later are sandwiched between the receiving plate 14c and the frame 16. Furthermore, mounting holes 16a are bored in an upper surface of the frame 16 to bind the bezel 13, the frame 16 and the chassis 14 and the like together with screws 19 and the like.

The optical sheet set 15 including the diffuser 15a and the optical sheets 15b is provided on the opening side of the chassis 14. The diffuser 15a includes a plate-like member made of a synthetic resin and light scattering particles dispersed in the plate-like member. The diffuser 15a has a function for diffusing point light emitted from the LEDs 17 as the point light sources. The outer edge part of the diffuser 15a is placed on the receiving plate 14c of the chassis 14 as described above, and does not receive a vertical firm restricting force.

The optical sheets 15b provided on the diffuser 15a have a sheet shape and a plate thickness thinner than that of the diffuser 15a, and the two sheets are laminated. Specific examples of the optical sheets 15b include a diffuser sheet, a lens sheet and a reflecting type polarizing sheet. These sheets can be suitably selected to be used. Light emitted from the LEDs 17 passes through the diffuser plate 15a. The optical sheets 15b have a function for converting the light to planar light. The liquid crystal panel 11 is placed on the upper surface side of the optical sheets 15b.

The reflection sheet 18 is provided on the bottom plate 14a and inner surfaces of the side plates 14b of the chassis 14 to cover the almost entire chassis 14. The reflection sheet 18 is made of a synthetic resin, and has a surface having white color that provides excellent light reflectivity. A hole part 18a is formed at a position corresponding to a diffuser lens 21 to be described later in the reflection sheet 18. Therefore, although the entire bottom plate 14a of the chassis 14 is covered with the reflection sheet 18, the diffuser lens 21 is exposed to the optical sheet set 15 side through the hole part 18a. The reflection sheet 18 obliquely rising from the edge part of the bottom plate 14a covers the inner surfaces of the side plates 14b. The outer edge part thereof is placed on the receiving plate 14c of the chassis 14. The light emitted from the LEDs 17 can be reflected to the diffuser 15a side by the reflection sheet 18.

Furthermore, an LED substrate (light source mounting substrate) 20 is placed on the inner surface of the bottom plate 14a of the chassis 14. The LEDs 17 and the diffuser lenses 21 are attached to the LED substrate 20. The LED substrate 20 is made of a synthetic resin. The LED substrate 20 has a surface on which a wiring pattern (not shown) including a metal film such as a copper foil is formed. The LEDs 17 are obtained by applying a fluorescent material having a light emitting peak in a yellow region to a blue light emitting chip emitting blue single color light. The LEDs 17 emit white color light. The LEDs 17 are electrically connected in series by the wiring pattern formed on the LED substrate 20.

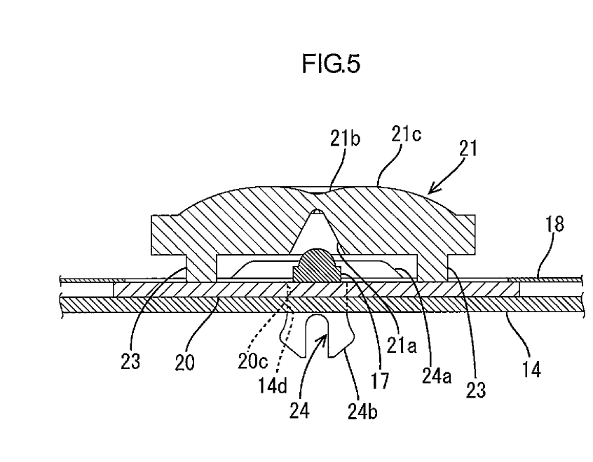

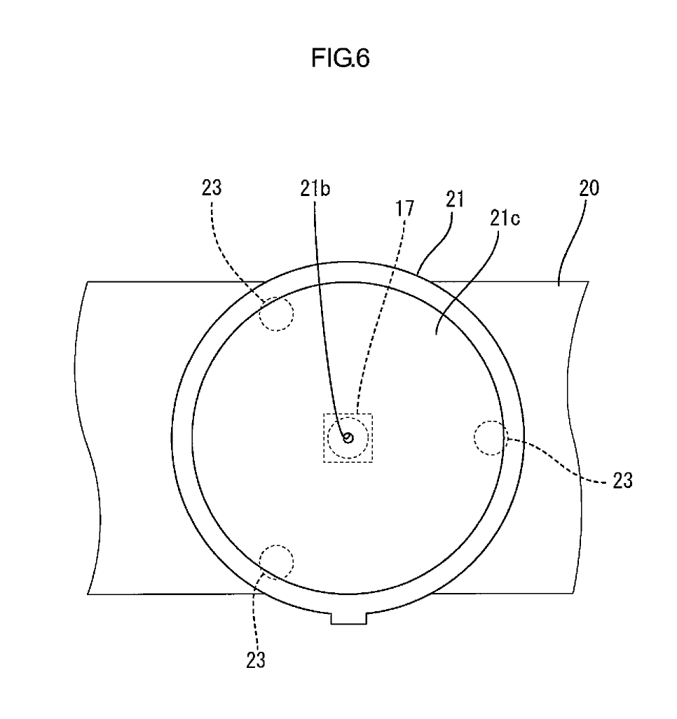

The diffuser lens 21 is a light diffusing member having excellent light diffusibility. For example, the diffuser lens 21 is made of a synthetic resin such as acrylic. As illustrated in FIG. 5, the diffuser lens 21 has a semispherical shape, and covers each of the LEDs 17. Three leg parts 23 are provided so as to protrude from a peripheral part of a lower surface of the diffuser lens 21. As illustrated in FIG. 6, the three leg parts 23 are arranged at approximately equal intervals (intervals of about 120 degrees) along a peripheral part of the diffuser lens 21. For example, the leg parts 23 are fixed to the surface of the LED substrate 20 by an adhesive or a thermosetting resin. An incident concave part 21a recessed to the upper side is formed in a lower surface (a surface opposite to the LED 17 and the LED substrate 20) of the diffuser lens 21. The incident concave part 21a is formed in a region overlapping with the LED 17 in a plan view in the lower surface of the diffuser lens 21. The incident concave part 21a has a substantially conical shape. Light from the LED 17 is made incident on the incident concave part 21a. The lower surface of the diffuser lens 21 is subjected to surface roughness processing such as surface texturing. On the other hand, a concave part 21b recessed to the lower side is formed in a center part (a region overlapping with the LED 17 in a plan view) of an upper surface (a surface opposite to the diffuser 15a) of the diffuser lens 21, and thereby a light output surface 21c having a shape obtained by connecting two gentle circular arcs is formed. The light emitted from the LED 17 is refracted between an air layer and the incident concave part 21a and between the light output surface 21c and the air layer, and thereby the light is diffused in a planar shape. The diffused light is radiated to the diffuser 15a side from the light output surface 21c over a wide angle range.

As illustrated in FIG. 5, the LED substrate 20 is fixed to the bottom plate 14a of the chassis 14 by a rivet 24. The rivet 24 has a disc-shaped holding part 24a and a locking part 24b protruding to the lower side from the holding part 24a. An insertion hole 20c into which the locking part 24b is inserted is bored in the LED substrate 20. A mounting hole 14d communicated with the insertion hole 20c is bored in the bottom plate 14a of the chassis 14. A tip part of the locking part 24b of the rivet 24 is an elastically deformable wide part. After the tip part is inserted into the insertion hole 20c and the mounting hole 14d, the tip part can be locked with a back surface side of the bottom plate 14a of the chassis 14. Thereby, the rivet 24 can fix the LED substrate 20 to the bottom plate 14a while the holding part 24a holds the LED substrate 20.

As illustrated in FIG. 2, a support pin 25 is provided so as to protrude from a surface of the rivet 24 located near a center part of the bottom plate 14a of the chassis 14. The support pin 25 has a tapered conical shape. When the diffuser 15a is distorted to the lower side, the diffuser 15a and a tip of the support pin 25 are brought into point contact with each other, and thereby the diffuser 15a can be supported from the lower side. The support pin 25 has also a function for easily treating the rivet 24 when the support pin 25 is grasped.

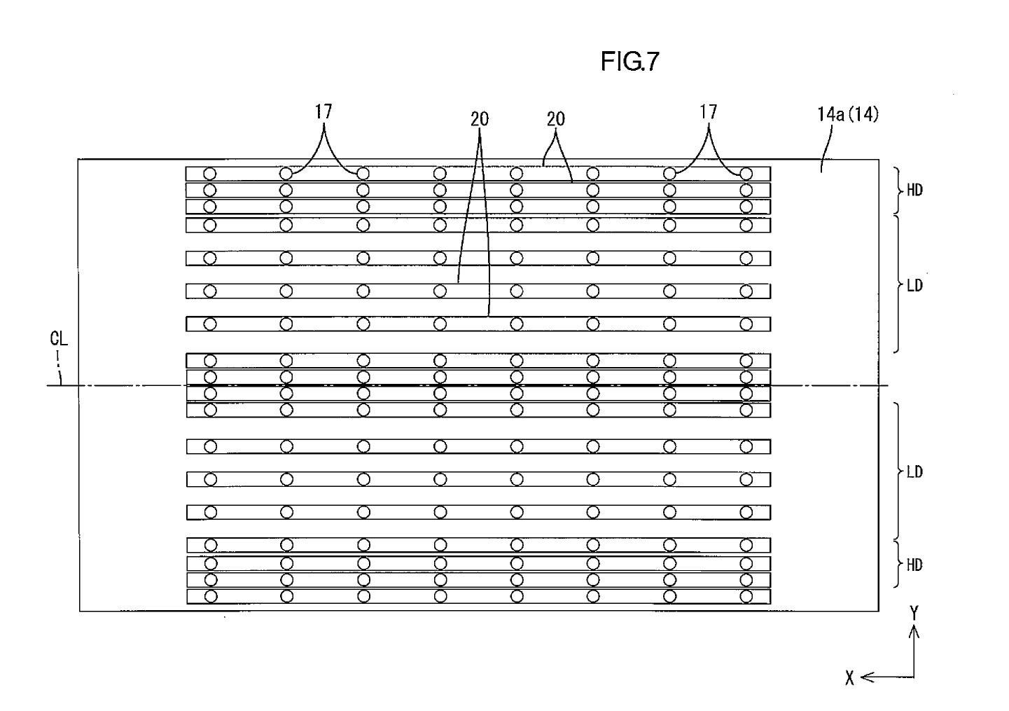

Then, the arrangement mode of the LED substrates 20 and LEDs 17 will be described using FIG. 7. FIG. 7 is a view schematically illustrating the arrangement mode of the LEDs in the chassis.

The LED substrate 20 is a plate-like member having a longitudinal shape as illustrated in FIG. 7. Eight LEDs 17 are arranged on a straight line (on a line) along a longitudinal direction of the LED substrate 20. More particularly, these eight LEDs 17 are surface-mounted at equal intervals on each of the LED substrates 20.

The LED substrates 20 are arranged such that a longitudinal direction thereof coincides with a long-side direction (X-axial direction) of the chassis 14. When the LED substrates 20 are viewed in a short-side direction (Y-axial direction) of the chassis 14, the eighteen LED substrates 20 are arranged parallel to each other. The arrangement mode of the LEDs 17 in each of the LED substrates 20 is made the same. The LEDs 17 are arranged parallel to each other in the short-side direction of the chassis 14. An external control unit which is not illustrated is connected to these LED substrates 20. Power required for lighting on of the LEDs 17 is supplied from the control unit, and thereby the LEDs 17 can be driven and controlled. In the present embodiment, the short-side direction and long-side direction of the chassis 14 respectively coincide with a vertical direction and horizontal direction of the television receiver TV.

Provided that a center line CL is drawn along the long-side direction (X-axial direction) of the bottom plate 14a on a center part in a parallel direction (the short-side direction of the bottom plate 14a, the Y-axial direction) of the LEDs 17, the LEDs 17 (LED substrates 20) are arranged to be axisymmetrical across the center line CL. More particularly, the LED substrates 20 are provided more densely in the farthest region (both end parts in the short-side direction of the bottom plate 14a) from the center line CL in the short-side direction of the bottom plate 14a than those in the other region. As a result, light source high-density areas HD are formed at both sides sandwiching the center line CL therebetween on both end parts in the vertical direction (short-side direction) of the bottom plate 14a. In the light source high-density areas HD, a distance between the adjacent LEDs 17 and 17 in the parallel direction (the short-side direction of the bottom plate 14a) is smaller than that of a surrounding region.

The LED substrates 20 are arranged more widely on an inner side (the centerline CL side, between the light source high-density area HD and the center line CL) of the region on which the light source high-density area HD is provided than those in the other region. As a result, light source low-density areas LD are formed, in which the distance between the adjacent LEDs 17 and 17 in the parallel direction (the short-side direction of the bottom plate 14a) is greater than that of the surrounding region.

Furthermore, the LED substrates 20 are arranged more widely than those in the light source high-density area HD and more densely than those in the light source low-density area LD between the light source low-density area LD and the center line CL. In other words, the distance between the adjacent LEDs 17 and 17 in the parallel direction (the short-side direction of the bottom plate 14a) is greater than the distance between the LEDs 17 and 17 in the light source high-density area HD between the light source low-density area LD and the center line CL, and is smaller than the distance between the LEDs 17 and 17 in the light source low-density area LD. Thus, the arrangement of the LEDs 17 has the light source high-density area HD and the light source low-density area LD and are arranged over the entire bottom plate 14a of the chassis 14.

As described above, provided that the center line CL is drawn along the X-axial direction on the center part in the parallel direction (Y-axial direction) of the plurality of LEDs 17 in the bottom plate 14a of the chassis 14 in the present embodiment, the light source high-density areas HD in which the distance between the adjacent LEDs 17 and 17 is smaller than that of the surrounding are formed at both sides sandwiching the center line CL therebetween.

According to such a configuration, an amount of illumination light can be increased in the region in which the light source high-density area HD is provided. When the LEDs 17 are arranged at equal intervals over the entire backlight device 12, brightness upon the upper and lower end parts or right and left end parts of the backlight device 12 tend to be lowered compared to the center part. However, as illustrated in the configuration of the present embodiment, the light source high-density areas HD are provided on the upper and lower end parts at both sides sandwiching the center line CL therebetween. Thereby the brightness of the upper and lower end parts can be improved. Thus, the brightness can be partially adjusted by the simple configuration, and an almost uniform illumination brightness distribution can be obtained over the entire backlight device 12.

In the present embodiment, the LEDs 17 are arranged to be axisymmetrical across the center line CL. In this case, the arrangement mode of the LEDs 17 is the same as that when the backlight device is vertically (laterally) inverted. Thereby, the almost uniform illumination brightness distribution can be obtained over the entire backlight device 12 irrespective of a use mode of the backlight device 12.

In the present embodiment, the light source high-density areas HD are formed on both end parts of the bottom plate 14a of the chassis 14. Since brightness upon the upper and lower end parts in which the brightness tends to be lowered in the backlight device 12 can be improved in this case, the almost uniform illumination brightness distribution can be obtained over the entire backlight device 12.

In the present embodiment, the light source low-density area LD in which the distance between the adjacent LEDs 17 and 17 is greater than that of the surrounding is formed between the center line CL and the light source high-density area HD. Such a configuration is suitable when the brightness upon the vicinity of the center part of the backlight device 12 is excessively raised. That is, by arranging the light source low-density area LD between the center line CL and the light source high-density area HD, the amount of illumination light is reduced in the light source low-density area LD, and thereby the brightness upon the vicinity of the center part can be lowered.

In the present embodiment, the LEDs 17 are arranged over the entire bottom plate 14a, and thereby illumination light can be radiated from an entire illumination surface of the backlight device 12.

In the present embodiment, the plurality of LED substrates 20 each of which the LEDs 17 are mounted on are arranged parallel to each other on the bottom plate 14a. The light source high-density areas HD are formed by reducing the distance between the adjacent LED substrates 20 and 20.

According to such a configuration, the distance between the adjacent LEDs 17 and 17 can be changed by changing the arrangement interval between the LED substrates 20 each of which the LEDs 17 are mounted on without arranging the LEDs 17 one by one on the bottom plate 14a while changing the interval between the LEDs 17 and 17. Thereby, working efficiency can be improved.

In the present embodiment, each of the LED substrates 20 may have a longitudinal shape. The plurality of LEDs 17 are linearly arranged along the longitudinal direction of each of the LED substrates 20. Since the installation mode of the LEDs 17 is unambiguously decided by the installation mode of the LED substrates 20 in this case, arrangement of the LEDs 17 is easily designed.

In the present embodiment, the bottom plate 14a has a rectangular shape in a plan view. The LED substrates 20 are arranged such that a longitudinal direction thereof coincides with the long-side direction of the bottom plate 14a.

According to such a configuration, the number of the LED substrates 20 can be decreased compared to a case where the longitudinal direction of each of the LED substrates 20 coincides with the short-side direction of the bottom plate 14a. Therefore, for example, the number of control units for controlling lighting on and off of the LEDs 17 can be decreased, and thereby cost reduction can be realized.

In the present embodiment, the diffuser lens 21 capable of diffusing light from each of the LEDs 17 is attached such that the diffuser lens 21 covers each of the LEDs 17. Since the light is diffused by the diffuser lens 21 in this case, a point lamp image is hardly occurred also when the interval between the adjacent LEDs 17 and 17 is increased. Therefore, the almost uniform luminance distribution can be obtained while cost reduction can be realized by reducing the number of the LEDs 17 to be arranged.

Since the diffuser lens 21 is the light diffusing member capable of diffusing light in the present embodiment, the light can be favorably diffused by the diffuser lens.

In the present embodiment, the diffuser lens 21 has the surface located on the LED substrate 20 side and subjected to surface roughness processing. Thus, the light can be more favorably diffused by subjecting the diffuser lens 21 to the surface roughness processing such as surface texturing.

Since the LEDs 17 are adopted as the light sources in the present embodiment, an increased life and reduction of consumption power and the like of the light source can be realized.

As described above, the first embodiment of the present invention has been illustrated. However, the present invention is not limited to the first embodiment, and may include following various modifications for example. In the following modifications, the same constituent parts and constituent elements as those of the above embodiment are indicated by the same symbols, and will not be described.

### First Modification of First Embodiment

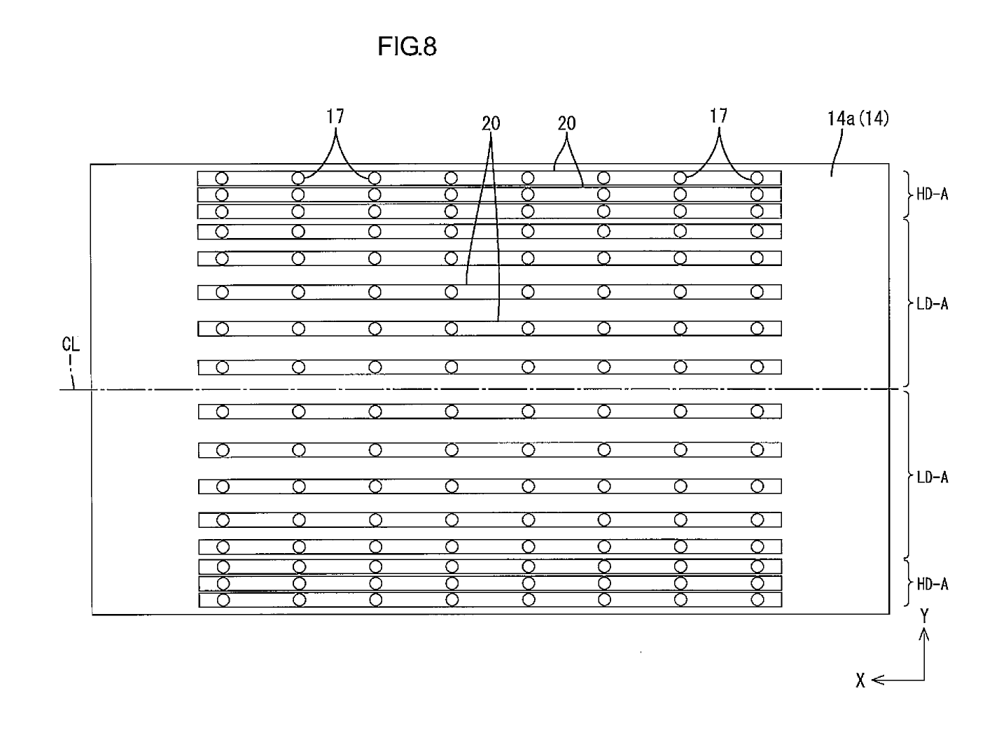

A modification of the arrangement mode of the LEDs 17 is illustrated in FIG. 8, and can be employed. FIG. 8 is a view schematically illustrating a modification of the arrangement mode of the LEDs in the chassis.

As illustrated in FIG. 8, the LED substrates 20 each of which the LEDs 17 are mounted on are arranged parallel to each other along the short-side direction (Y-axial direction) of the bottom plate 14a such that a longitudinal direction of each of the LEDs 17 coincides with the long-side direction (X-axial direction) of the bottom plate 14a of the chassis 14. More particularly, the LED substrates 20 are arranged more densely in the farthest region (both end parts of the bottom plate 14a) from the center line CL in the short-side direction of the bottom plate 14a than those in the other region. Light source high-density areas HD-A are formed at both sides sandwiching the center line CL therebetween. In the light source high-density areas HD-A, the distance between the adjacent LEDs 17 and 17 in the parallel direction (the short-side direction of the bottom plate 14a) is smaller than that of the surrounding region. Light source low-density areas LD-A are formed between the light source high-density areas HD-A and the center line CL. In the light source low-density areas LD-A, the distance between the adjacent LEDs 17 and 17 in the parallel direction (the short-side direction of the bottom plate 14a) is greater than that of the surrounding region. That is, in this example, the light source low-density areas LD-A are provided on the center part side of the bottom plate 14a, and the light source high-density areas HD-A are provided on both end parts in the short-side direction of the bottom plate 14a.

The configuration of this example is suitable when improving the brightness of the end part while suppressing excessive high brightness of the center part of the backlight device 12. Since the light source low-density areas LD-A are provided in the entire region other than the end part of the bottom plate 14a, the numbers of the LEDs 17 and LED substrates 20 can be reduced. This configuration can contribute to cost reduction of the backlight device 12.

### Second Modification of First Embodiment

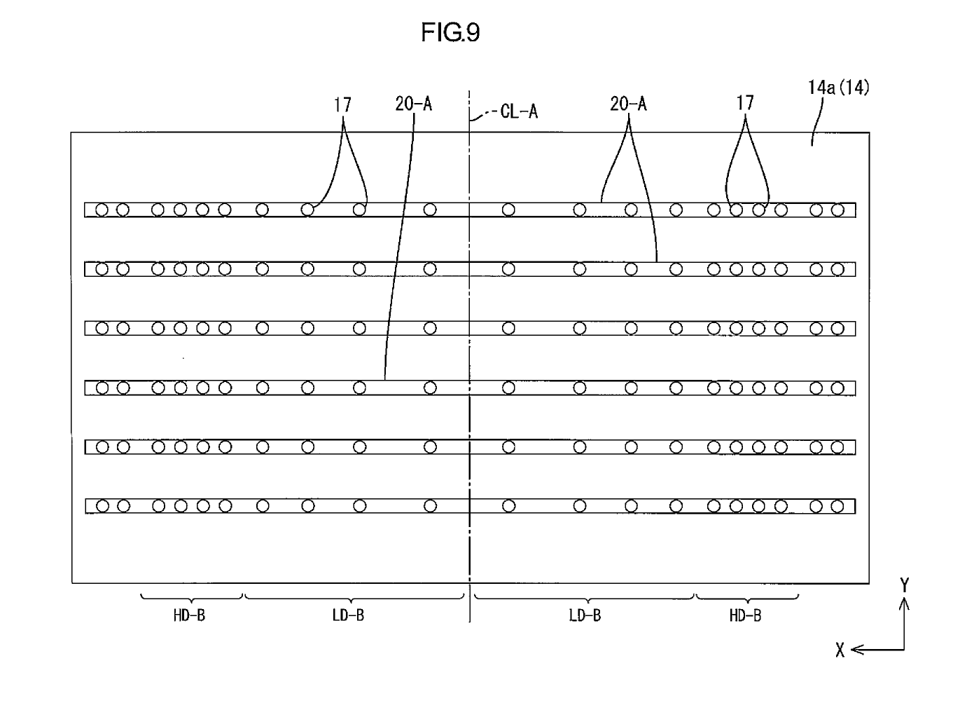

A modification of the arrangement mode of the LEDs 17 is illustrated in FIG. 9, and can be employed. FIG. 9 is a view schematically illustrating another modification of the arrangement mode of the LEDs in the chassis.

As illustrated in FIG. 9, a plurality of LED substrates 20-A each of which the LEDs 17 are mounted on are arranged along the short-side direction (Y-axial direction) of the bottom plate 14a of the chassis 14 such that a longitudinal direction of each of the LED substrates 20-A coincides with the long-side direction (X-axial direction) of the chassis 14. More particularly, the six LED substrates 20-A are arranged parallel to each other at equal intervals along the short-side direction of the bottom plate 14a.

The twenty LEDs 17 are arranged on each of the LED substrates 20-A parallel to each other on a straight line (on a line) along the longitudinal direction of each of the LED substrates 20-A. Herein, provided that a center line CL-A is drawn along the short-side direction (Y-axial direction) of the bottom plate 14a on the center part in the parallel direction (the long-side direction of the bottom plate 14a, the X-axial direction) of the LEDs 17, the LEDs 17 are arranged to be axisymmetrical across the centerline CL-A. More particularly, light source low-density areas LD-B are formed in a region adjacent to the center line CL-A. In the light source low-density areas LD-B, the distance between the adjacent LEDs 17 and 17 in the parallel direction (the long-side direction of the bottom plate 14a) is greater than that in the other region. Light source high-density areas HD-B are formed at both sides sandwiching the center line CL-A therebetween on the outer side (on the side opposite to the center line CL-A) of the region in which the light source low-density area LD-B is provided. In the light source high-density areas HD-B, the distance between the adjacent LEDs 17 and 17 in the parallel direction (the long-side direction of the bottom plate 14a) is smaller than that in the other region. Furthermore, the distance between the adjacent LEDs 17 and 17 is greater than the distance between the LEDs 17 and 17 in the light source high-density area HD-B, and is smaller than the distance between the LEDs 17 and 17 in the light source low-density area LD-B on the outer side (on the side opposite to the center line CL-A, the end part in the long-side direction of the bottom plate 14a) of the light source high-density area HD-B.

As described above, according to this example, the light source high-density areas HD-B are formed by reducing the distance between the adjacent LEDs 17 and 17 on one LED substrate 20, and the brightness upon the intended region (in this example, the right and left end parts) can be improved. Particularly, according to the configuration of this example, the light source low-density areas LD-B are formed on the center part side (the region adjacent to the center line CL-A) of the backlight device 12, and the light source high-density area HD-B is formed on the outer side of each of the light source low-density areas LD-B. Thereby, the configuration of this example is suitable when improving the brightness of the end part while suppressing excessive high brightness of the center part of the backlight device 12.

### Third Modification of First Embodiment

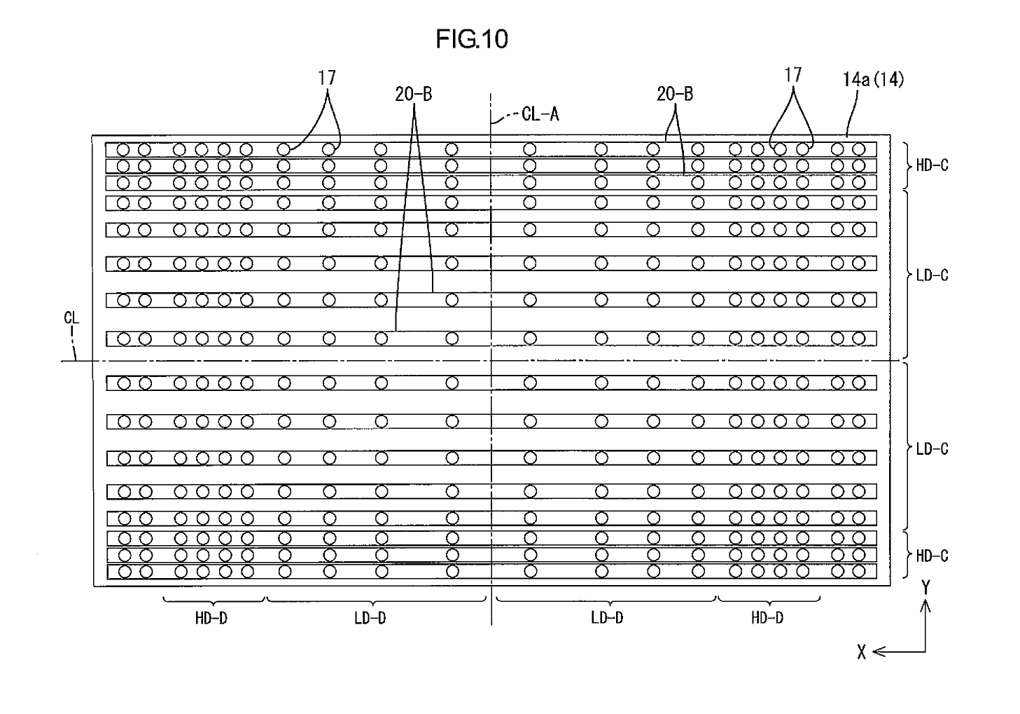

Another modification of the arrangement mode of the LEDs 17 is illustrated in FIG. 10, and can be employed. FIG. 10 is a view schematically illustrating still another modification of the arrangement mode of the LEDs in the chassis.

As illustrated in FIG. 10, a plurality of LED substrates 20-B each of which the LEDs 17 are mounted on are arranged parallel to each other along the short-side direction (Y-axial direction) of the bottom plate 14a of the chassis 14 such that a longitudinal direction of each of the LED substrates 20-B coincides with the long-side direction (X-axial direction) of the chassis 14. Herein, provided that the center line CL is drawn along the long-side direction of the bottom plate 14a on a center part in a first parallel direction (the short-side direction of the bottom plate 14a, the short-side direction of the LED substrate 20-B) of the LEDs 17, the LEDs 17 are arranged to be axisymmetrical across the center line CL. More particularly, the LED substrates 20-B are arranged more densely in the farthest region (both end parts in the vertical direction of the bottom plate 14a) from the center line CL in the short-side direction of the bottom plate 14a than those in the other region. First light source high-density areas HD-C are formed at both sides sandwiching the center line CL therebetween. In the first light source high-density areas HD-C, a distance between the adjacent LEDs 17 and 17 in the first parallel direction (the short-side direction of the bottom plate 14a, the short-side direction of the LED substrate 20-B) is smaller than that of a surrounding region. First light source low-density areas LD-C are formed between the first light source high-density area HD-C and the center line CL. In the first light source low-density areas LD-C, a distance between the adjacent LEDs 17 and 17 in the first parallel direction (the short-side direction of the bottom plate 14a, the short-side direction of the LED substrate 20-B) is greater than that of a surrounding region. That is, in this example, the first light source low-density areas LD-C are provided on the center part side in the short-side direction of the bottom plate 14a, and the first light source high-density areas HD-C are provided on both end parts in the vertical direction of the bottom plate 14a.

The twenty LEDs 17 are arranged on each of the LED substrates 20-B parallel to each other on a straight line (on a line) along the longitudinal direction of each of the LED substrates 20-B. Herein, provided that a center line CL-A is drawn along the short-side direction of the bottom plate 14a on the center part in a second parallel direction (the long-side direction of the bottom plate 14a, the longitudinal direction of the LED substrate 20-B) of the LEDs 17, the LEDs 17 are arranged to be axisymmetrical across the center line CL-A. More particularly, second light source low-density areas LD-D are formed in a region adjacent to the center line CL-A. In the second light source low-density areas LD-D, the distance between the adjacent LEDs 17 and 17 in the second parallel direction (the long-side direction of the bottom plate 14a, the longitudinal direction of the LED substrate 20-B) is greater than that in the other region. Second light source high-density areas HD-D are formed at both sides sandwiching the center line CL-A therebetween on the outer side (on the side opposite to the center line CL-A) of the region in which the second light source low-density areas LD-D are provided. In the second light source high-density areas HD-D, the distance between the adjacent LEDs 17 and 17 in the second parallel direction (the long-side direction of the bottom plate 14a, the longitudinal direction of the LED substrate 20-B) is smaller than that in the other region. Furthermore, the distance between the adjacent LEDs 17 and 17 is greater than the distance between the LEDs 17 and 17 in the second light source high-density area HD-D, and is smaller than the distance between the LEDs 17 and 17 in the second light source low-density area LD-D on the outer side (on the side opposite to the center line CL-A, both end parts in the horizontal direction in the long-side direction of the bottom plate 14a) of the second light source high-density area HD-D.

According to the configuration of this example, the first light source low-density areas LD-C and the second light source low-density areas LD-D are formed on the center part sides in the short-side and long-side directions of the bottom plate 14a of the chassis 14, and the first light source high-density areas HD-C and the second light source high-density areas HD-D are formed on the outer sides thereof. Therefore, the brightness upon the upper and lower end parts and right and left end parts can be improved while excessive high brightness of the center part of the backlight device 12 can be suppressed.

### Second Embodiment

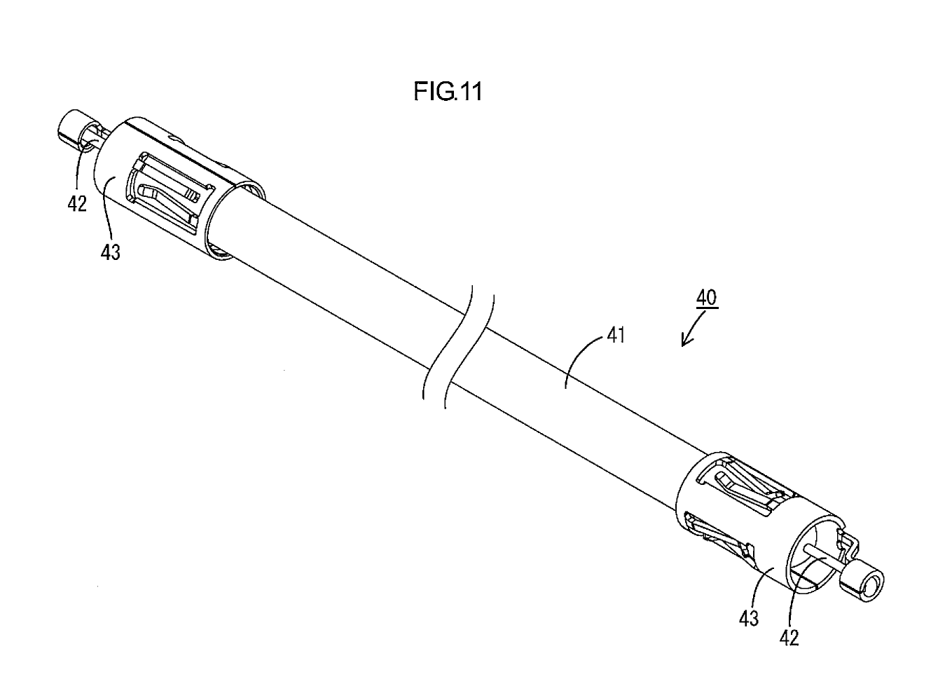

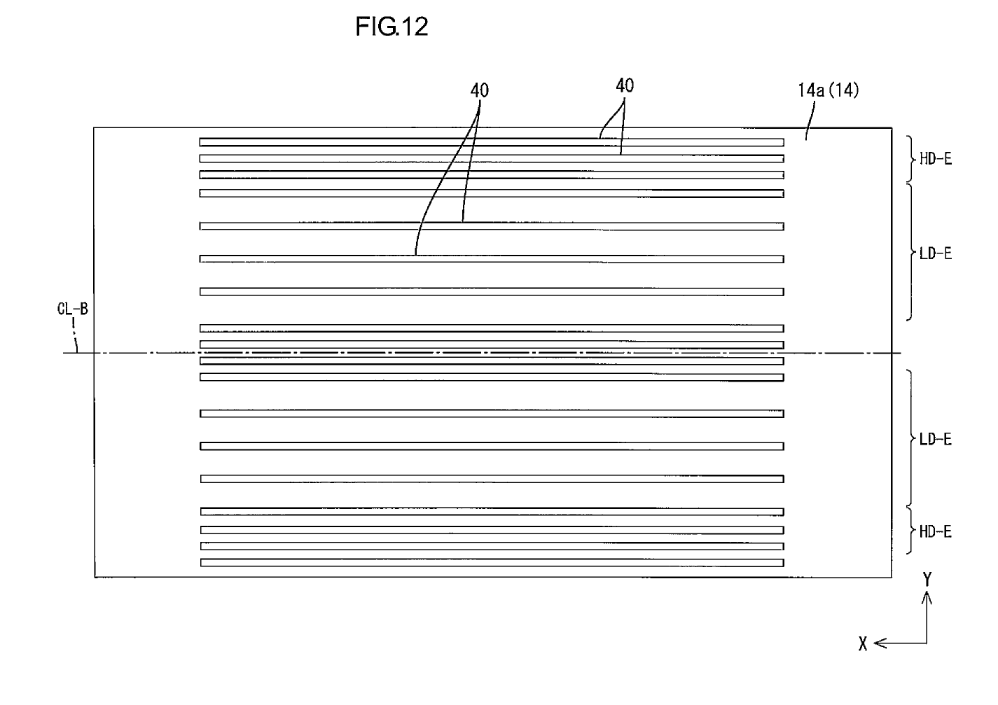

Next, a second embodiment of the present invention will be described with reference to FIGS. 11 to 12. In the second embodiment, the mode of the light source changed from the first embodiment is illustrated. The other configurations are same as the above first embodiment. The same parts as the above first embodiment are indicated by the same symbols and will not be described.

FIG. 11 is a perspective view illustrating a schematic configuration of a cold-cathode tube. FIG. 12 is a view schematically illustrating an arrangement mode of cold-cathode tubes in a chassis.

As illustrated in FIG. 11, a cold-cathode tube (linear light source) 40 which is a light source in the present embodiment includes an elongated glass tube 41 of which both ends are sealed, an elongated metal (for example, iron-nickel alloy) outer lead 42 having a circular cross section protruding from both end parts of the glass tube 41, and approximately cylindrical ferrules 43 provided on both the end parts of the glass tube 41. Mercury and the like is enclosed in the glass tube 41, and an inner wall surface of the glass tube 41 is coated with a fluorescent material. Regions covered with the ferrules 43 of both the end parts are non-light emitting regions. A center region (that is, a region coated with the fluorescent material) other than the non-light emitting regions is a light emitting region.

As illustrated in FIG. 12, the numerous cold-cathode tubes 40 are arranged parallel to each other in the short-side direction (Y-axial direction) of the bottom plate 14a such that a longitudinal direction (axial direction) of each of the cold-cathode tubes 40 coincides with the long-side direction (X-axial direction) of the bottom plate 14a of the chassis 14. Herein, provided that a center line CL-B is drawn along the long-side direction (X-axial direction) of the bottom plate 14a on a center part in the parallel direction (the short-side direction of the bottom plate 14a, the Y-axial direction) of the cold-cathode tubes 40, the cold-cathode tubes 40 are arranged to be axisymmetrical across the center line CL-B. More particularly, light source high-density areas HD-E are formed at both sides sandwiching the center line CL-B therebetween in the farthest region (both end parts in the short-side direction of the bottom plate 14a) from the center line CL-B in the short-side direction of the bottom plate 14a. In the light source high-density areas HD-E, a distance between the adjacent cold-cathode tubes 40 and 40 in the parallel direction (the short-side direction of the bottom plate 14a) is smaller than that of a surrounding region.

The LED substrates 20 are arranged more widely on an inner side (between the light source high-density area HD-E and the center line CL-B) of the region on which the light source high-density area HD-E is provided than those in the other region. Light source low-density areas LD-E are formed, in which the distance between the adjacent cold-cathode tubes 40 and 40 in the parallel direction (the short-side direction of the bottom plate 14a) is greater than that of the surrounding region.

Furthermore, the distance between the adjacent cold-cathode tubes 40 and 40 in the parallel direction (the short-side direction of the bottom plate 14a) is greater than the distance between the cold-cathode tubes 40 and 40 in the light source high-density area HD-E between the light source low-density area LD-E and the center line CL-B, and is smaller than the distance between the cold-cathode tubes 40 and 40 in the light source low-density area LD-E. Thus, the arrangement of the cold-cathode tubes 40 has the light source high-density area HD-E and the light source low-density area LD-E. The cold-cathode tubes 40 are arranged over the entire bottom plate 14a of the chassis 14.

As described above, provided that the center line CL-B is drawn along the X-axial direction on the center part in the parallel direction (Y-axial direction) of the plurality of cold-cathode tubes 40 in the bottom plate 14a of the chassis 14 in the present embodiment, the light source high-density areas HD-E in which the distance between the adjacent cold-cathode tubes 40 and 40 is smaller than that of the surrounding exist at both sides sandwiching the center line CL-B therebetween.

According to such a configuration, an amount of illumination light can be increased in the region in which the light source high-density area HD-E is provided. When the cold-cathode tubes 40 are arranged at equal intervals over the entire backlight device 12, brightness upon the upper and lower end parts or right and left end parts of the backlight device 12 tend to be reduced compared to the center part. However, as illustrated in the configuration of the present embodiment, by providing the light source high-density areas HD-E on the upper and lower end parts at both sides sandwiching the center line CL-B therebetween, the brightness upon the upper and lower end parts can be improved. Thereby, an almost uniform illumination brightness distribution can be obtained over the entire backlight device 12.

In the present embodiment, the cold-cathode tube 40 which is the linear light source is employed as the light source. Thereby, the light source high-density areas HD-E can be easily formed by arranging the cold-cathode tubes 40 parallel to each other and changing the arrangement interval thereof.

In the present embodiment, the cold-cathode tubes 40 are arranged such that the longitudinal direction thereof coincides with the long-side direction of the bottom plate 14a. According to such a configuration, the number of the cold-cathode tubes 40 can be decreased compared to the case where the longitudinal direction of each of the cold-cathode tubes 40 coincides with the short-side direction of the bottom plate 14a. Therefore, for example, the number of control units for controlling lighting on and off of the cold-cathode tubes 40 can be decreased, and thereby cost reduction can be realized.

### Modification of Second Embodiment

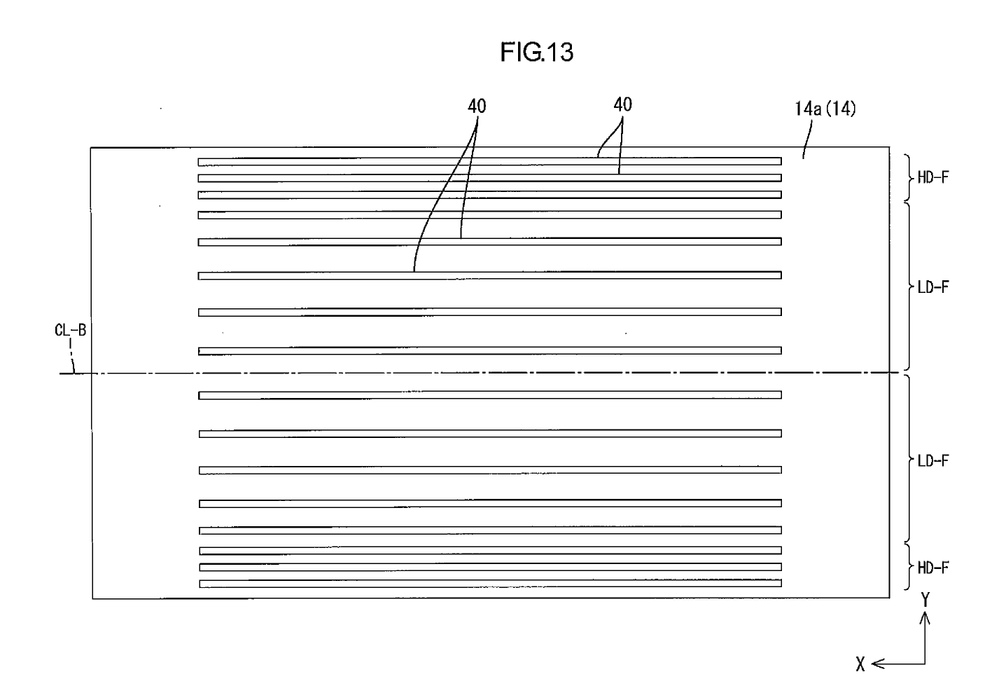

A modification of the arrangement mode of the cold-cathode tubes 40 is illustrated in FIG. 13, and can be employed. FIG. 13 is a view schematically illustrating a modification of the arrangement mode of the cold-cathode tubes in the chassis.

As illustrated in FIG. 13, the cold-cathode tubes 40 are arranged parallel to each other along the short-side direction (Y-axial direction) of the bottom plate 14a such that a longitudinal direction of the each of the cold-cathode tubes 40 coincides with the long-side direction (X-axial direction) of the bottom plate 14a of the chassis 14. More particularly, light source high-density areas HD-F are formed at both sides sandwiching the center line CL-B therebetween in the farthest region (both end parts in the short-side direction of the bottom plate 14a) from the center line CL-B in the short-side direction of the bottom plate 14a. In the light source high-density areas HD-F, the distance between the adjacent cold-cathode tubes 40 and 40 in the parallel direction (the short-side direction of the bottom plate 14a) is smaller than that of the surrounding region. Light source low-density areas LD-F are formed between the light source high-density area HD-F and the center line CL-B. In the light source low-density areas LD-F, the distance between the adjacent cold-cathode tubes 40 and 40 in the parallel direction (the short-side direction of the bottom plate 14a) is greater than that of the surrounding region. That is, in this example, the light source low-density areas LD-F are provided on the center part side in the short-side direction of the bottom plate 14a, and the light source high-density areas HD-F are provided on both end parts in the short-side direction of the bottom plate 14a.

The configuration of this example is suitable when improving the brightness of the end part while suppressing excessive high brightness of the center part of the backlight device 12. Since the light source low-density areas LD-E are provided in the entire region other than the end part of the bottom plate 14a, the numbers of the cold-cathode tubes 40 can be reduced. This configuration can contribute to cost reduction of the backlight device 12.

### Other Embodiment

As describe above, the embodiments of the present invention have been described. However, the present invention is not limited to the above embodiments described in the above description and the drawings. The following embodiments are also included in the technical scope of the present invention, for example.

(1) In the above first embodiment, one LED substrate is arranged along the long-side direction of the bottom plate of the chassis. However, for example, the plurality of LED substrates arranged along the long-side direction of the bottom plate may be electrically or physically connected to each other by a connector and the like.

(2) In the above first embodiment, the LEDs obtained by applying a fluorescent material having a light emitting peak in a yellow region to a blue light emitting chip emitting blue single color light are exemplified. However, for example, three kinds of red, green, and blue LED chips may be surface-mounted.

(3) In the above first embodiment, the LEDs aligned and arranged in the reticular pattern in the longitudinal and lateral directions are exemplified. However, for example, the LEDs may be arranged in a hexagonal closest form, that is, such that all distances between the adjacent LEDs are equivalent, or the LEDs may be alternately arranged.

(4) In the above first embodiment, the diffuser lenses arranged so as to cover the LEDs are exemplified. However, the diffuser lenses may not be necessarily arranged. In this case, the occurrence of the point lamp image can be suppressed by densely arranging the LEDs.

(5) In the above first embodiment, the number of the LEDs arranged on the LED substrate is 8 or 20. However, the number of the LEDs arranged on the LED substrate is optional.

(6) In the above first embodiment, the LEDs used as the point light sources are exemplified. However, the point light sources other than the LEDs may be used.

(7) In the above second embodiment, the cold-cathode tubes are used as the linear light sources. However, for example, the other linear light sources such as hot-cathode tubes may be used.

(8) In the above embodiments, the optical sheet set obtained combining the diffuser, the diffuser sheet, the lens sheet, and the reflecting type polarizing sheet is exemplified. However, for example, an optical sheet obtained by laminating two diffusers can also be employed.

1. A lighting device comprising:
a plurality of light sources arranged parallel to each other; and
a chassis having a bottom plate on which the light sources are arranged,
wherein some of the plurality of light sources are arranged on either side of a center line of the bottom plate at a center with respect to a parallel arrangement direction of the plurality of light sources in a light source high-density area in which a distance between the adjacent light sources is smaller than a distance between the adjacent light sources of others of the plurality of light sources in another area.

2. The lighting device according to claim 1, wherein the light sources are arranged to be axisymmetrical across the center line.

3. The lighting device according to claim 1, wherein the light source high-density area is provided near either end of the bottom plate.

4. The lighting device according to claim 1, wherein some of the plurality of light sources are arranged in a light source low-density area in which a distance between the adjacent light sources is greater than the distance between the adjacent light sources of the others of the plurality of light sources in the other area, the light source low-density area that is provided between the center line and the light source high-density area.

5. The lighting device according to claim 1, wherein the light sources are arranged over the entire bottom plate.

6. The lighting device according to claim 1, further comprising a plurality of light source mounting substrates, wherein:
the light sources are point light sources mounted on each of the plurality of light source mounting substrates; and
the plurality of light source mounting substrates are arranged parallel to each other on the bottom plate and such that a distance between the adjacent light source mounting substrates is small in the light source high-density area.

7. The lighting device according to claim 6, wherein
the plurality of point light sources are mounted on each of the plurality of light source mounting substrates and arranged such that a distance between the adjacent point light sources is small in the light source high-density area.

8. The lighting device according to claim 6, wherein:
each of the light source mounting substrates has a longitudinal shape; and
the plurality of point light sources are linearly arranged along a longitudinal direction of each of the light source mounting substrates.

9. The lighting device according to claim 6, wherein:
the bottom plate has a rectangular shape in a plan view; and
each of the light source mounting substrates has a longitudinal shape, and is arranged with a longitudinal direction thereof aligned with a long-side direction of the bottom plate.

10. The lighting device according to claim 6, wherein a diffuser lens configured to diffuse light from each of the point light sources is attached such that the diffuser lens covers each of the point light sources.

11. The lighting device according to claim 10, wherein the diffuser lens is a light diffusing member configured to diffuse light.

12. The lighting device according to claim 10, wherein the diffuser lens has a substrate-side surface subjected to surface roughness processing.

13. The lighting device according to claim 6, wherein each of the point light sources is an LED.

14. The lighting device according to claim 1, wherein each of the light sources is a linear light source.

15. The lighting device according to claim 14, wherein:
the bottom plate has a rectangular shape in a plan view; and
the linear light sources are arranged with a longitudinal direction thereof aligned with a long-side direction of the bottom plate.

16. A display device comprising:
the lighting device according to claim 1; and
a display panel configured to provide display using light from the lighting device.

17. The display device according to claim 16, wherein the display panel is a liquid crystal panel using liquid crystals.

18. A television receiver comprising the display device according to claim 16.
